(19) United States
(12) Patent Application Publication
(10) Pub. No.: US 2026/0154300 A1
(43) Pub. Date: Jun. 4, 2026

(54) ELECTRONIC DEVICE PERFORMING USER-REQUESTED TASK USING MULTI-AGENT AND OPERATION METHOD THEREOF

(71) Applicant: SAMSUNG ELECTRONICS CO., LTD., Suwon-si (KR)

(72) Inventor: Jonghyun HO, Suwon-si (KR)

(73) Assignee: SAMSUNG ELECTRONICS CO., LTD., Suwon-si (KR)

(21) Appl. No.: 19/377,394

(22) Filed: Nov. 3, 2025

Related U.S. Application Data
(63) Continuation of application No. PCT/KR2025/017082, filed on Oct. 24, 2025.

(30) Foreign Application Priority Data
Nov. 29, 2024 (KR) 10-2024-0175654
Jan. 24, 2025 (KR) 10-2025-0011308
Oct. 23, 2025 (KR) 10-2025-0154995

(51) Int. Cl. G06F 16/3329; G06F 3/04817

(52) U.S. Cl. CPC G06F 16/33295; G06F 3/04817

(57) ABSTRACT

A method of an electronic device, includes: receiving a user query through an input device; identifying a requested task from the user query by a first agent among a plurality of agents in memory of the electronic device; decomposing the requested task into at least one sub task; requesting, to a second agent managing metadata for the plurality of agents, metadata for at least one agent capable of processing the at least one sub task; receiving, from the second agent, an answer including the metadata; configuring a multi-agent by selecting at least one agent to process the at least one sub task, from among the plurality of agents based on the answer; performing a natural language conversation to delegate the at least one sub task to each agent; and determining whether to reconfigure the multi-agent based on a result of the natural language conversation.

### CROSS-REFERENCE TO RELATED APPLICATIONS

This application is a by-pass continuation application of International Application No. PCT/KR2025/017082, filed on Oct. 24, 2025, which is based on and claims priority to Korean Patent Application No. 10-2024-0175654, filed on Nov. 29, 2024, Korean Patent Application No. 10-2025-0011308, filed on Jan. 24, 2025, and Korean Patent Application No. 10-2025-0154995, filed on Oct. 23, 2025, in the Korean Intellectual Property Office, the disclosures of which are incorporated by reference herein their entireties.

### BACKGROUND

### 1. Field

The disclosure relates to an electronic device performing a user-requested task using multi-agent and an operation method of the electronic device.

### 2. Related Art

A large language model (LLM) is an artificial intelligence model that learns a large volume of text data to understand and generate natural language. The LLM is primarily based on a transformer structure, which is suitable for large-scale data learning due to its capability for parallel processing. The core of the transformer is an attention mechanism, which effectively identifies relationships between words in an input sentence and enables understanding of context. Accordingly, the LLM may perform various tasks, such as answering complex questions, summarizing documents, and translation, beyond simple sentence generation.

The LLM is trained using billions of parameters that contribute to learning various patterns and grammatical structures of language. High-performance computing resources and large-scale datasets are needed for training the LLM. The LLM may be further adjusted for specific tasks through fine-tuning. Recently, services such as chatbots, content generation, and data analysis using LLMs have been provided.

The above-described information may be provided as related art for the purpose of helping understanding of the disclosure. No claim or determination is made as to whether any of the foregoing is applicable as background art in relation to the disclosure.

### SUMMARY

According to an aspect of the disclosure, an electronic device includes: an input device; a display; memory storing instructions and a plurality of programs corresponding to a plurality of agents; and at least one processor including processing circuitry, wherein the instructions, when executed by the at least one processor individually or collectively, cause the electronic device to: receive a user query through the input device; identify, by a first agent among the plurality of agents, a requested task from the user query; decompose the requested task into at least one sub task; request, from a second agent managing metadata for the plurality of agents, metadata for at least one agent capable of processing the at least one sub task; receive, from the second agent, an answer including the metadata; configure, based on the answer, a multi-agent by selecting at least one agent to process the at least one sub task from among the plurality of agents; perform a natural language conversation to delegate the at least one sub task to each agent of the multi-agent; and determine whether to reconfigure the multi-agent based on a result of the natural language conversation.

According to an aspect of the disclosure, a method of an electronic device, includes: receiving a user query through an input device of the electronic device; identifying a requested task from the user query by a first agent among a plurality of agents stored in memory of the electronic device; decomposing the requested task into at least one sub task; requesting, from a second agent managing metadata for the plurality of agents, metadata for at least one agent capable of processing the at least one sub task; receiving, from the second agent, an answer including the metadata; configuring a multi-agent by selecting at least one agent to process the at least one sub task, from among the plurality of agents based on the answer; performing a natural language conversation to delegate the at least one sub task to each agent; and determining whether to reconfigure the multi-agent based on a result of the natural language conversation.

According to an aspect of the disclosure, a non-transitory computer-readable storage medium storing instructions, wherein the instructions, when executed by one or more processors individually or collectively, cause the one or more processors to: receive a user query through an input device; identify a requested task from the user query by a first agent among a plurality of agents; decompose the requested task into at least one sub task; request, from a second agent managing metadata for the plurality of agents, metadata for at least one agent capable of processing the at least one sub task; receive, from the second agent, an answer including the metadata; configure, based on the answer, a multi-agent by selecting at least one agent to process the at least one sub task from among the plurality of agents; perform a natural language conversation to delegate the at least one sub task to each agent of the multi-agent; and determine whether to reconfigure the multi-agent based on a result of the natural language conversation.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates an electronic device in a network environment according to one or more embodiments;

FIG. 2 illustrates an LLM-based agent framework according to an embodiment of the disclosure;

FIG. 3 illustrates collaborative operations using multi-agent of an electronic device according to an embodiment of the disclosure;

FIG. 4 is a flowchart illustrating operations of an electronic device processing a user-requested task using multi-agent according to an embodiment of the disclosure;

FIGS. 5A and 5B illustrate an example of a conversation screen of multi-agent according to an embodiment of the disclosure;

FIG. 6 is a flowchart illustrating an operation of searching for an agent of an electronic device according to an embodiment of the disclosure;

FIG. 7 illustrates an example of agent groups according to an embodiment of the disclosure;

FIG. 8 is a flowchart illustrating operations of processing a user-requested task of an electronic device according to an embodiment of the disclosure;

FIG. 9 illustrates an example of an activated agent group according to an embodiment of the disclosure;

FIG. 10 is a flowchart illustrating operations of processing a user-requested task of an electronic device according to an embodiment of the disclosure;

FIG. 11 is a flowchart illustrating operations of generating an agent of an electronic device according to an embodiment of the disclosure;

FIG. 12A illustrates an example of an agent selection screen of an electronic device according to an embodiment of the disclosure;

FIG. 12B illustrates an example of a new agent generation screen of an electronic device according to an embodiment of the disclosure;

FIG. 12C illustrates an example of a user agent list screen of an electronic device according to an embodiment of the disclosure;

FIG. 13 illustrates an example of a tool invocation operation of LLM-based agents according to an embodiment of the disclosure;

FIG. 14A illustrates an example of a conversation screen of a user-configured agent team according to an embodiment of the disclosure; and

FIG. 14B illustrates an example of an action screen of a user-configured agent team according to an embodiment of the disclosure.

### DETAILED DESCRIPTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

Hereinafter, embodiments of the disclosure are described in detail with reference to the accompanying drawings.

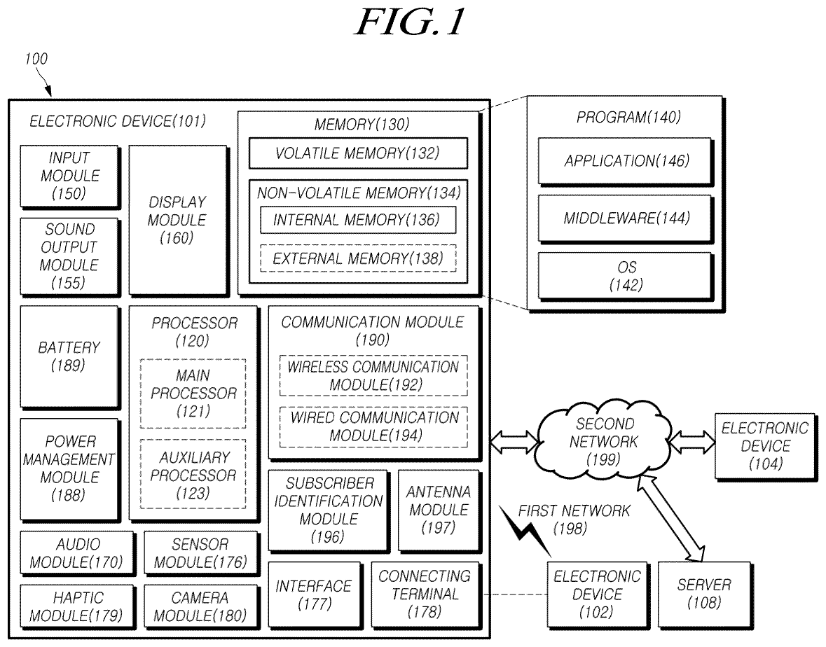

FIG. 1 is a block diagram illustrating an electronic device in a network environment according to various embodiments.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the sub processor 123, the sub processor 123 may be configured to use lower power than the main processor 121 or to be specified for a designated function. The sub processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., through a wire or wires) or wirelessly coupled with the electronic device 101.

The sensor module 176 may detect an operation state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., through a wire or wires) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low-latency services using, e.g., distributed computing or mobile edge computing. In another embodiment, the external electronic device 104 may include an Internet-of-things (IoT) device. The server 108 may be an intelligent server using machine learning or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

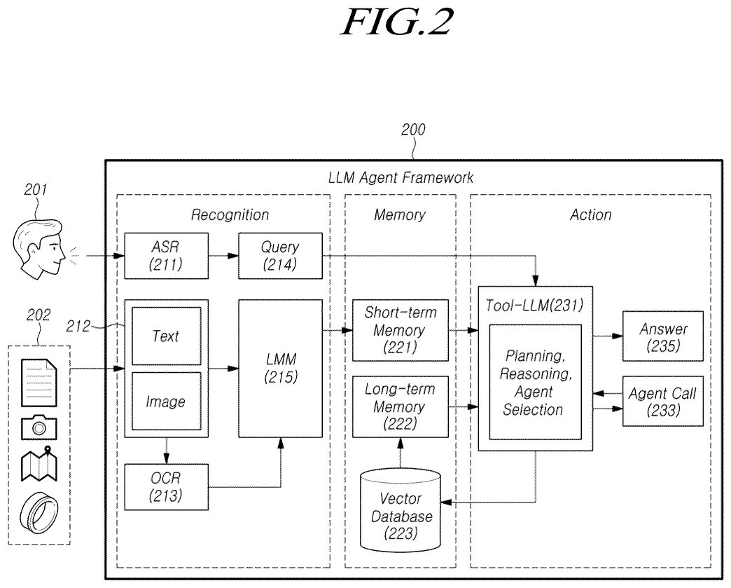

FIG. 2 illustrates an LLM-based agent framework according to an embodiment of the disclosure.

According to an embodiment, an electronic device (e.g., the electronic device 101 of FIG. 1) may process a user-requested task using an LLM-based agent and generate an answer corresponding to the user-requested task. The electronic device 101 may recognize information from input data obtained through an input device (e.g., a microphone, camera, or display) and identify a query. The electronic device 101 may refine data related to the query and store and manage the refined data in short-term or long-term memory (e.g., the memory 130 of FIG. 1). In order to process the query, the electronic device 101 may derive an answer through conversations of multi-agent interworking through various application programming interfaces (APIs) without boundaries, based on data stored in the memory. A framework 200 for an LLM-based agent may include an input data recognition stage, an information memory stage, and an agent action stage, for an agent to interact with the environment and to perform functions.

According to an embodiment, the electronic device 101 may receive text or voice 201 through an input device (e.g., the input module 150 of FIG. 1). When voice is input, the electronic device 101 may convert the voice into a text using the automatic speech recognition (ASR) 211 to identify the user query 214.

According to an embodiment, the electronic device 101 may receive additional data 202 besides the user query. For example, the electronic device 101 may receive documents and queries and generate answers to the queries based on a document analysis. The additional data 202 may include at least one of documents, photos, videos, location information, or sensor data. The electronic device 101 may obtain the information 212 analyzed from images, videos, or documents obtained as the additional data 202. For example, the electronic device 101 may recognize text in an image using the OCR 213. The electronic device 101 may process modality data using the large multimodal model (LMM) 215. The electronic device 101 may analyze the additional data 202 using the LMM 215 and may extract and store necessary data in the memory.

According to an embodiment, the electronic device 101 may store recognized information in short-term or long-term memory and may refer to past data related to the user query.

The short-term memory 221 may retain information necessary to complete tasks through several stages. The electronic device 101 may classify the subject of input data through the LMM 215 in the input data recognition stage and may store the input data in the short-term memory 221 to maintain the context of the current conversation. The electronic device 101 may perceive changes in the subject of input data and may retrieve information stored in the short-term memory 221.

The electronic device 101 may merge recognized information with information stored in the long-term memory 222 or, if conflicting, may update the recognized information using the LMM 215. The electronic device 101 may retain the classified information (e.g., user preferences) in the long-term memory 222. The classified information may be embedded by the tool-based LLM 231 and stored in the vector database 223.

According to an embodiment, the electronic device 101 may generate an answer to the user query 214 using the tool-based LLM 231. The tool-based LLM 231, in combination with a modularized tool, may perform specific tasks. The LLM, which processes queries based on text, may handle more complex tasks by calling or controlling modularized tools. The tool of the tool-based LLM 231 may be an API. The tool may include, e.g., a calendar, phone, contacts, web search, user interface guide, notifications, messages, calculator, translator, or document generator. The tool-based LLM 231 may configure multi-agents through planning, reasoning, and agent selection to generate the answer 235 to the user query 214, and process sub tasks by calling each multi-agent (agent call 233). The operation of calling each multi-agent (233) may be performed in the form of a natural language conversation (question and answer) between the multi-agents. The electronic device 101 may output the question and answer between the multi-agents through a output device (e.g., a display) as a process of deriving the answer 235 to the user query 214.

According to an embodiment, an LLM-based agent is a software program capable of conversing in natural language with a human or another agent. For example, an agent may be a chatbot capable of natural language conversation. The agent may be programmed to perform predetermined functions. For example, the agent may be programmed to retrieve information, summarize documents, provide natural language conversation, understand natural language questions and generate corresponding answers, perform actions based on problem-solving by understanding context, provide descriptions and examples for specific domains, generate text according to given requirements, translate languages, analyze documents, and classify, decompose, and automate tasks composed of one or more actions. The agent may have a goal to achieve and may be optimized for a specific domain (or specific function) through fine-tuning. For example, a search agent may provide text or image search functions. The search target may be set as web data, specific databases, or cloud servers. According to an embodiment, each agent may be configured with a separate LLM or may share a single LLM. When sharing the single LLM, each multi-agent act as an interface to perform functions in a specific domain. For example, the electronic device 101 may be connected to a server comprising an LLM and a search agent and a travel agent included in the multi-agent may each perform their respective tasks using the LLM in the server. In the disclosure, for convenience of description, the LLM-based agent may be referred to as “an agent.”

According to an embodiment, the electronic device 101 may allow LLM-based agents to perform sub tasks to achieve a goal corresponding to the user query. For example, a manager agent may perform task decomposition to plan complex tasks. The manager agent may analyze the user's intent from the user query and establish a task plan. The manager agent may configure multi-agents. The multi-agents may include one or more agents to perform sub tasks of the task plan. The manager agent may invoke the multi-agents (e.g., web search agent, phone call agent) to delegate sub tasks. The manager agent may identify errors in planning or execution based on the answers of multi-agents. In response to errors, the manager agent may change sub tasks or change the agent to execute the sub tasks. In an embodiment, the manager agent may be referred to by another name. For example, it may be a main agent or host agent. Alternatively, the name of the agent performing the role of the manager agent may be set or modified by the user.

The electronic device 101 may generate a final answer and provide the final answer to the user upon achieving the goal according to the conversation among multi-agent processing the decomposed sub tasks of the task corresponding to the user query. The electronic device 101 may provide a user with a process for configuring a multi-agent and a conversation between the multi-agents. The conversation between the multi-agents may consist of questions and responses in natural language, and may also include information about the agent that is the speaker. The electronic device 101 may provide a summary of the conversation among the multi-agent along with the final answer. The summary may include main process of deriving the final answer to the user query. The electronic device 101 may output the conversation between the multi-agents, the summary, and the final answer through a display.

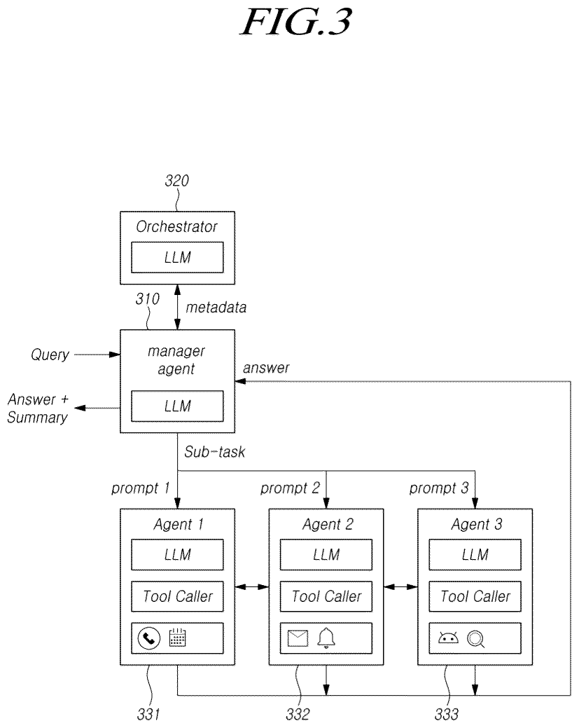

FIG. 3 illustrates collaborative operations using a multi-agent of an electronic device according to an embodiment of the disclosure.

According to an embodiment, the electronic device (e.g., the electronic device 101 of FIG. 1) may derive an answer through the collaboration of the multi-agent upon receiving the user query. The electronic device 101 may provide the user with the conversation between the multi-agent in the process of reaching the final answer. The electronic device 101 may output the collaborative process of multi-agents in a dialogue format, where they exchange questions and answers with each other.

According to an embodiment, the electronic device 101 may include multiple agents. The multiple agents may include a manager agent 310, an orchestrator 320, and task processing agents 331, 332, 333. The agents illustrated in FIG. 3 are merely examples, and the types and numbers of agents are not limited. The distinctions are only used to describe the operations of multiple agents, and the distinctions between the agents may vary in various embodiments. As illustrated in FIG. 3, the manager agent 310, the orchestrator 320, and the agents 331, 332, and 333 may each include an LLM and may request and perform tasks through natural language conversations with each other. In an embodiment, the LLM may be implemented in each agent, or multiple agents may share and utilize a single LLM. In the latter case, each agent may act as an interface for requesting tasks from the single LLM and receiving responses. The LLM may be included within the electronic device 101, a server, or another device.

According to an embodiment, the electronic device 101 may configure the multi-agent to process the user query using the manager agent 310. The manager agent 310 may obtain agent information suitable for processing the user query from an orchestrator 320. The orchestrator 320 may be a type of an agent that stores and manages metadata for agents. The orchestrator 320 may search for the agent to process the requested task or sub task corresponding to the user query. The orchestrator 320 may be included in the electronic device 101 or may be located in a separate storage device or server.

The manager agent 310 may classify or decompose the user-requested task into one or more sub tasks to request an agent search from the orchestrator 320. For example, the user-requested task may be “Do A and B,” where sub tasks A and B may be performed sequentially. The user-requested task may be “Do C,” but in order to achieve task C, it may be necessary to infer and sequentially perform sub tasks D, E, and F. The manager agent 310 may classify tasks by referring to information stored in the short-term memory or long-term memory related to the user-requested task.

The manager agent 310 may search for the agent to perform each of the sub tasks from the orchestrator 320. The orchestrator 320 may deliver metadata for the searched agent to the manager agent 310. The manager agent 310 may configure the multi-agent including at least one agent to process the user-requested task.

The multi-agent may process sub tasks sequentially through a conversation. The manager agent 310 may generate a prompt to delegate sub tasks to the agents. The manager agent 310 may decompose the user-requested task into three sub tasks, specify three agents (a first agent 331, a second agent 332, a third agent 333) to process the sub tasks, respectively, and generate three prompts (prompt1, prompt2, prompt3) to delegate the sub tasks, respectively. The manager agent 310 may request a first sub task from a first agent 331 using a first prompt (prompt1) and receive the corresponding answer. For example, the first agent 331 may utilize a phone API and a calendar API to process the first prompt. If the first agent 331 determines that additional data is required to perform the first sub task, the first agent 331 may select an agent from among the multi-agents to request additional data and request the selected agent to provide the additional data. At this time, the first agent 331 may generate a natural language prompt for requesting the additional data, transmit the generated prompt to the selected agent, and receive a response including the additional data from the selected agent.

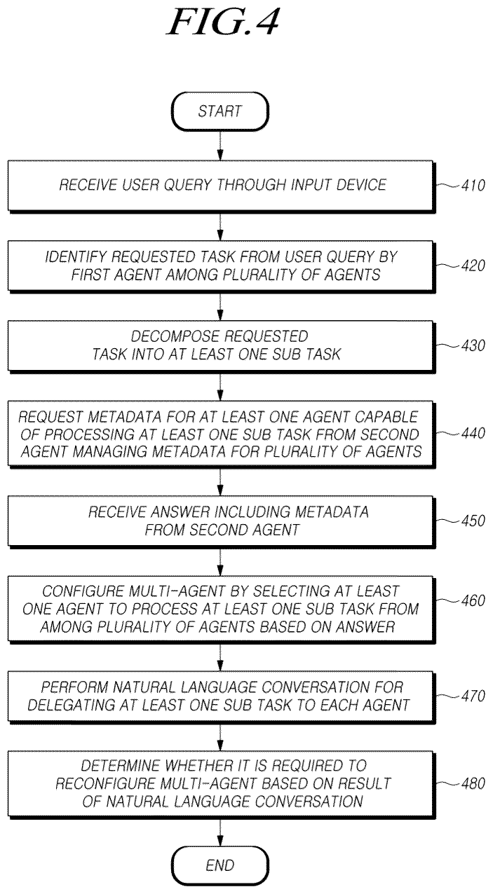

FIG. 4 is a flowchart illustrating operations of an electronic device processing a user-requested task using multi-agent according to an embodiment of the disclosure.

According to an embodiment, the electronic device (e.g., the electronic device 101 of FIG. 1) may perform an action as a result of processing the user-requested task based on the conversation among the multi-agent. The action may be one or more execution results including the provision of an answer. The electronic device 101 may provide the user with a basis for judgment regarding action performance by summarizing the natural language conversation among the multi-agent, i.e., prompt transmission and answer reception. In the following embodiment, each operation may be sequentially performed, but, in other embodiments, each operation may not necessarily be performed sequentially. For example, the order of the operations may be changed, and at least two operations may be performed in parallel.

In operation 410, the electronic device 101 may receive a user query through an input device (e.g., the input module 150 of FIG. 1) (e.g., a keyboard, a microphone). The electronic device 101 may receive a query in natural language form, i.e., a user-requested task. For example, the electronic device 101 may receive a voice such as “Help me plan a summer vacation” through a microphone. The electronic device 101 may extract a query from the voice through ASR (e.g., the ASR 211 of FIG. 2).

In operation 420, the electronic device 101 may identify a requested task from a user query using the first agent (e.g., the manager agent 310 of FIG. 3) among a plurality of agent stored in the memory (e.g., the memory 130 of FIG. 1) of the electronic device 101. The manager agent 310 may analyze the natural language query to identify the user-requested task.

In operation 430, the electronic device 101 may decompose or divide the requested task into at least one sub task. The sub task may be a unit that each agent may process. For example, detailed schedules for a summer vacation plan may be specified as planning a travel itinerary and collecting travel-related information. The travel itinerary planning may be processed by a travel agent, and the travel-related information collection may be processed by a search agent.

In operation 440, the electronic device 101 may request metadata for at least one agent capable of processing at least one sub task from a second agent (e.g., the orchestrator 320 of FIG. 3) managing metadata for a plurality of agents. The manager agent 310 may generate a prompt that requests agent information capable of processing sub tasks and transmit the prompt to the orchestrator 320.

In operation 450, the electronic device 101 may receive an answer including metadata from the second agent. The orchestrator 320 may transmit the metadata of agents capable of processing sub tasks as an answer to the manager agent 310.

In operation 460, the electronic device 101 may configure a multi-agent by selecting at least one agent to process at least one sub task from among the plurality of agents based on the answer. For example, the manager agent 310 may configure the multi-agent including the travel agent and the search agent to establish the summer vacation plan.

In operation 470, the electronic device 101 may perform a natural language conversation to delegate at least one sub task to each agent. The multi-agent including the manager agent 310 may perform the natural language conversation by generating a natural language prompt for each sub task and transmitting the prompt to each agent. The natural language conversation may include queries using prompts and corresponding responses. For example, when agent A sends a natural language prompt to agent B, agent B may generate an answer to the natural language prompt and reply to agent A. Agent A may proceed with the next sub task according to agent B's answer. The electronic device 101 may continue the conversation among the multi-agent until all sub tasks are completed.

In operation 480, the electronic device 101 may determine whether to reconfigure the multi-agent based on the result of the natural language conversation. For example, the electronic device 101 may determine to reconfigure the multi-agent based on determining, during the conversation among the multi-agent, that a third agent is unable to generate an answer to a first sub task.

When the manager agent 310 may transmit, to the orchestrator 320, a prompt to request the metadata for another agent to process the first sub task. The manager agent 310 may receive an answer including metadata for a fourth agent and reconfigure the multi-agent including the fourth agent. For example, the fourth agent may be included in the multi-agent in place of the third agent, or the fourth agent may be added while the third agent remains included in the multi-agent.

The electronic device 101 may process the remaining sub tasks, including the first sub task, through the conversation among the reconfigured multi-agent.

The electronic device 101 may change the remaining sub tasks or change the configuration of the multi-agent according to, or based on, the answers from the multi-agent. When the multi-agent determines that additional information is needed to generate an answer, the multi-agent may ask another agent or the user for the additional information.

When the conversation among the multi-agent is completed, the electronic device 101 may generate the final answer and generate summary information of the conversation among the multi-agent and output them. The electronic device 101 may output the final answer and the summary information through an output device (e.g., the display module 160 of FIG. 1). The electronic device 101 may describe the answer generation process to the user by providing the summary information along with the answer to the user-requested task.

The electronic device 101 may include an input device 150, a display 160, memory 130 including a plurality of programs corresponding to a plurality of agents, and at least one processor 120 including processing circuitry. The memory 130 may store instructions, when executed by the at least one processor 120 individually or collectively, causing the electronic device 101 to receive a user query through the input device 150, identify a requested task from the user query by a first agent among the plurality of agents, decompose the requested task into at least one sub task, request metadata for at least one agent capable of processing the at least one sub task from a second agent managing metadata for the plurality of agents, receive an answer including the metadata from the second agent, configure multi-agent by selecting at least one agent to process the at least one sub task from among the plurality of agents based on the answer, perform a natural language conversation to delegate the at least one sub task to each agent, and determine whether to reconfigure the multi-agent based on a result of the natural language conversation.

According to an embodiment, the memory 130 may store instructions that, when executed by the at least one processor 120 individually or collectively, cause the electronic device 101 to, in response to determining that a third agent is incapable of generating an answer to a first sub task during a conversation among the multi-agent as whether to reconfigure the multi-agent, request, by the first agent to the second agent, metadata for another agent to process the first sub task, receive, from the second agent, an answer including metadata for a fourth agent capable of processing the first sub task, and reconfigure, by the first agent, the multi-agent including the fourth agent.

According to an embodiment, the memory 130 may store instructions that, when executed by the at least one processor 120 individually or collectively, cause the electronic device 101 to process a rest of the at least one sub task through a conversation among the reconfigured multi-agent, in response to completion of the conversation among the multi-agent, generate a final answer and summary information for the conversation among the multi-agent, and output the final answer and the summary information through the display.

According to an embodiment, the memory 130 may store instructions that, when executed by the at least one processor 120 individually or collectively, cause the electronic device 101 to reflect, by the first agent, each response according to the conversation among the multi-agent to remaining sub tasks.

According to an embodiment, the memory 130 may store instructions that, when executed by the at least one processor 120 individually or collectively, cause the electronic device 101 to, when some of the remaining sub tasks are changed by reflecting each response to the conversation among the multi-agent, determine, by the first agent, whether the multi-agent are capable of processing the changed sub tasks, based on determining that the multi-agent are incapable of processing the changed sub tasks, request, to the second agent, metadata for an additional agent to process the changed sub tasks, receive the metadata for the additional agent from the second agent, and reconfigure, by the first agent, the multi-agent including the additional agent.

According to an embodiment, the memory 130 may store instructions that, when executed by the at least one processor 120 individually or collectively, cause the electronic device 101 to display, by the first agent, information about the multi-agent through the display, and sequentially output a natural language prompt query and response, in an inter-agent conversation format through the display according to a real-time conversation of the multi-agent.

According to an embodiment, the memory 130 may store instructions that, when executed by the at least one processor 120 individually or collectively, cause the electronic device 101 to receive a user input through the input device during the conversation among the multi-agent, and reflect, by the first agent, the user input to a remaining sub task among the at least one sub task.

According to an embodiment, the memory 130 may store instructions that, when executed by the at least one processor 120 individually or collectively, cause the electronic device 101 to add the fourth agent to the multi-agent or replace the third agent with the fourth agent, and output a guide for changing the multi-agent through the display.

According to an embodiment, the memory 130 may store instructions that, when executed by the at least one processor 120 individually or collectively, cause the electronic device 101 to receive meta information for agent generation through the input device, generate a new agent based on the meta information, and store the new agent and metadata for the new agent in the memory.

According to an embodiment, the meta information may include at least one of an agent name, a trigger condition, a target, a function, a tool, an API, training data, LLM information, or a generation condition.

According to an embodiment, the memory 130 may store instructions that, when executed by the at least one processor 120 individually or collectively, cause the electronic device 101 to generate, by the plurality of agents, an answer to an input prompt based on a large language model.

According to an embodiment, the memory 130 may store instructions that, when executed by the at least one processor 120 individually or collectively, cause the electronic device 101 to generate the answer or perform an action related to the answer, by the plurality of agents, using a tool corresponding to one or more modularized functions stored in the memory.

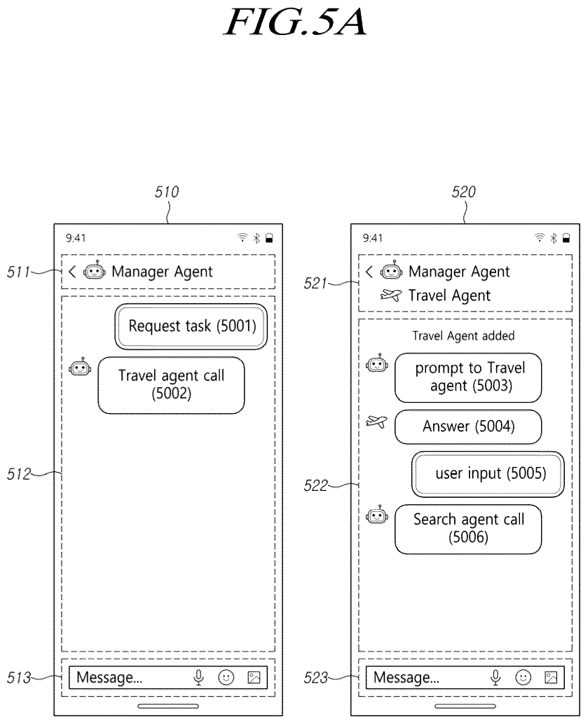

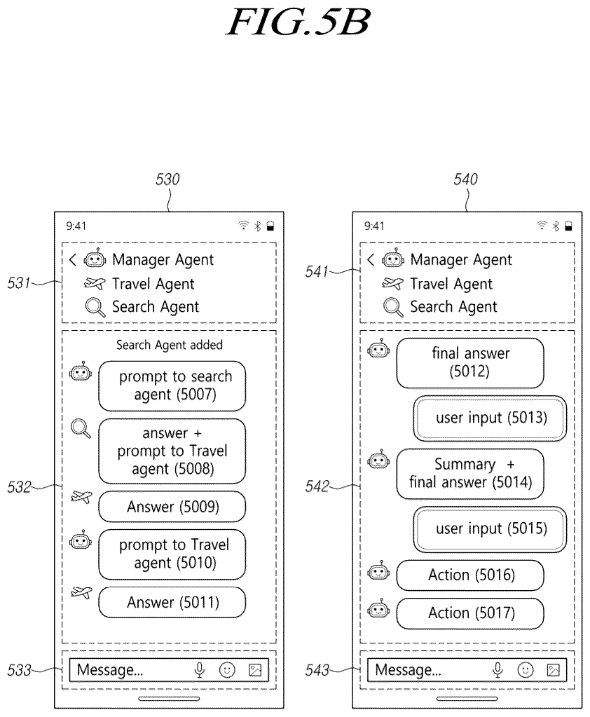

FIGS. 5A and 5B illustrate an example of a conversation screen of multi-agent according to an embodiment of the disclosure.

The electronic device (e.g., the electronic device 101 of FIG. 1) may output the conversation among multi-agent in the process of processing the user-requested task through a display screen. FIGS. 5A and 5B illustrate consecutive first, second, third, and fourth screens 510, 520, 530, 540 displaying the conversation among multi-agent in the process of processing the user-requested task “Help me plan a summer vacation.”

The first screen 510 to the fourth screen 540 may include a first area 511, 521, 531, 541 displaying the multi-agent, a second area 512, 522, 532, 542 displaying the conversation by the multi-agent and the user, and a third area 513, 523, 533, 543 corresponding to a input window for receiving user input.

The first area 511 of the first screen 510 may include a manager agent (e.g., the manager agent 310 of FIG. 3) as a basic agent configuring the multi-agent and receiving user queries. The manager agent 310 may receive a requested task through a user input and determine the agent to process the requested task.

The second area 512 of the first screen 510 may display the reception of a user input 5001 for “Help me plan a summer vacation.” The second area 512 may include the configuration of a travel agent as multi-agent for the manager agent 310 to process a user input. The electronic device 101 may display the conversation 5002 such as “I will request the Travel Agent to help plan the vacation” in the second area 512 in response to the operation of including the travel agent in the multi-agent.

In the first area 521 of the second screen 520, the multi-agent including the manager agent 310 and the travel agent may be displayed. In the second area 522, a message indicating the addition of the Travel Agent may be output. The manager agent 310 may transmit a first prompt 5003, “Plan a vacation considering the calendar schedule,” to delegate sub tasks to the travel agent, and may display the first prompt 5003 in the second area 522. The travel agent may generate, as a first answer 5004 to the first prompt 5003, “The vacation schedule is the last week of July. Recently, many Koreans have visited places such as Jeju Island domestically, and Guam and Phu Quoc internationally,” and may output the first answer 5004 in the second area 522. The electronic device 101 may receive “Search and let me know which place is better among them,” as the user conversation 5005 through the third area 523 during the conversation among the multi-agent, and may output the user conversation 5005 input in the second area 522. In response to the input of the user conversation 5005, the manager agent 310 may specify a search agent as the agent for processing the user's request and may include the search agent in the multi-agent. The electronic device 101 may display the conversation 5006, such as “I will request the Search Agent to help search for travel site information,” in the second area 522 in response to the operation of including the search agent in the multi-agent.

In the first area 531 of the third screen 530, the multi-agent including the manager agent 310, the travel agent, and the search agent may be displayed. In the second area 532, a message indicating the addition of the Search Agent may be output. The manager agent 310 may transmit a second prompt 5007, “Search for the latest travel site information about Jeju Island, Guam, and Phu Quoc and let me know which is the best place to visit,” to delegate sub tasks to the search agent, and may display the second prompt 5007 in the second area 532. The search agent may generate, as a second answer to the second prompt 5007, “Recently, Guam is not recommended as tourists are evacuating due to a typhoon.” The search agent may generate a conversation, “Please check if there are flights to Jeju Island and Phu Quoc,” as a third prompt for delegating sub tasks to the travel agent in relation to the second answer. As a conversation between the search agent and the travel agent, the second answer and the third prompt 5008 may be output in the second area 532. The travel agent may generate, as a third answer 5009 to the third prompt 5008, “There are no available flights to Jeju Island for the designated schedule. For Phu Quoc, there are products available for both flights and accommodations,” and may output the third answer 5009 in the second area 532. The manager agent 310 may generate, as a fourth prompt 5010, “Can you recommend something within a 3 million won budget for a family of three who travels often? Make sure it has a king bedroom!” to delegate sub tasks to the travel agent in response to the third answer 5009, and may output the fourth prompt 5010 in the second area 532. The travel agent may generate, as a fourth answer 5011 to the fourth prompt 5010, “The Jeju flight on XX day at XX hour, and Phu Quoc Vinpearl Resort are available for booking,” and may output the fourth answer 5011 in the second area 532.

In the first area 541 of the fourth screen 540, the current multi-agent including the manager agent 310, the travel agent, and the search agent may be displayed. In the second area 542, the multi-agent 310 may output, as the final answer 5012 to the user input 5001, a conversation, “The Jeju flight on XX day at XX hour, and Phu Quoc Vinpearl Resort are available for booking.” The electronic device 101 may receive “Summarize why this decision was made,” as a user input 5013 for the final answer 5012 through the third area 543, and may output the received user input 5013 in the second area 542. The manager agent may generate summary of the conversation among the multi-agent and the final answer 5014 as an answer to the user input 5013. The final answer 5014 may be “Guam is not recommended due to a typhoon causing tourist evacuations, and there are no available flights to Jeju Island. Phu Quoc is available for booking on XX day at XX hour with Vinpearl Resort in the XXX budget. Shall we proceed this way?” In the second area 542, the summarized information and the final answer 5014 may be output.

The electronic device 101 may receive a final decision as a user input 5015 for the final answer 5014. The user input 5015 may include an acceptance intention such as “Yes, please proceed.” The electronic device 101 may perform actions related to sub tasks (e.g., executing flight reservations, executing accommodation reservations) in response to, or based on, receiving the final decision from the user. The manager agent 310 may output a conversation as the action result 5016 for the sub tasks in the second area 542, “Both the flight and accommodation have been booked. The reservation details have been sent through email.” The manager agent 310 may store user preference information in the long-term memory based on the action result 5016, and may output a conversation “User preference information is being stored” in the second area 542.

The first screen 510, the second screen 520, the third screen 530, and the fourth screen 540 show an example of displaying the configuration and conversation among the multi-agent for deriving an answer to the user input 5001, “Help me plan a summer vacation.” The electronic device 101 may output a natural language conversation among the multi-agent on the screen and provide the final answers 5011, 5014. The electronic device 101 may summarize the conversation content by the user request 5013 or automatically output the conversation content on the screen.

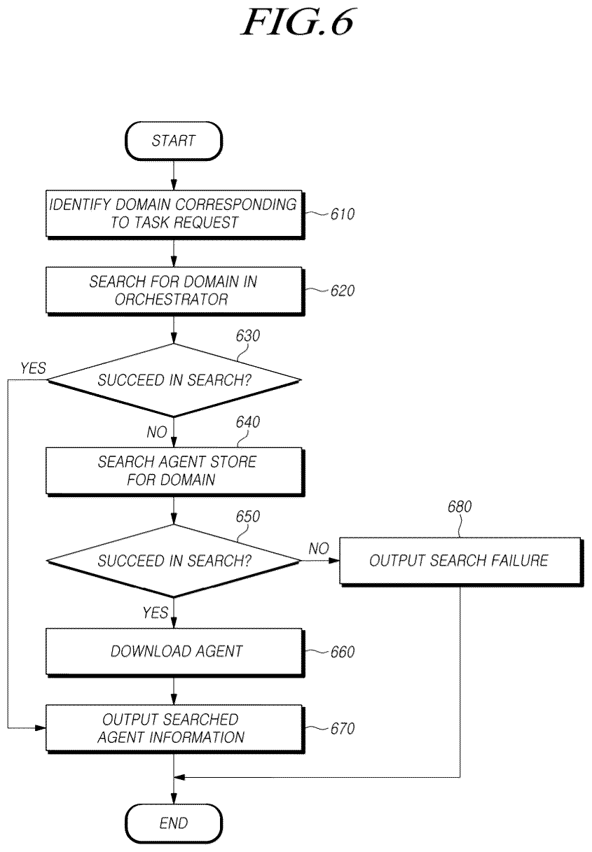

FIG. 6 is a flowchart illustrating an operation of searching for an agent of an electronic device according to an embodiment of the disclosure.

The electronic device (e.g., the electronic device 101 of FIG. 1) may search for the agent for processing the user task request using an orchestrator (e.g., the orchestrator 320 of FIG. 3). In the following embodiment, each operation may be sequentially performed, but, in other embodiments, each operation is not necessarily performed sequentially. For example, the order of the operations may be changed, and at least two operations may be performed in parallel.

In operation 610, the electronic device 101 may identify a domain corresponding to a task request using the manager agent (e.g., the manager agent 310 of FIG. 3). For example, the manager agent 310 may distinguish a domain to which the task request belongs among health, education, productivity, entertainment, shopping, music, movies, or social network service (SNS) from the user query. The type of domain may be determined based on metadata of agents. Similar metadata may be included in the same domain group. The domain may be classified into a parent group and a sub group. The domain may also be determined in detail according to the degree of subdivision of the task request. For example, when the task request is “Recommend daily exercise,” the task request may be classified as exercise. When the task request is “Recommend good stretching postures to do every morning,” the task request may be classified as a more subdivided domain, such as home training stretching.

In operation 620, the electronic device 101 may request a domain search from the orchestrator 320. The orchestrator 320 may search for agents included in the domain.

In operation 630, when the agent included in the domain is present, the electronic device 101 may succeed in the domain search. When the orchestrator 320 succeeds in the search, the orchestrator 320 may select the agent included in the domain. For example, when there are a plurality of agents included in the domain, the orchestrator 320 may select any one based on user preferences stored in memory.

In operation 640, when the orchestrator 320 fails in the search from the orchestrator 320 (operation 630, No), the electronic device 101 may search the agent store for the corresponding domain. The agent store may represent a platform in which agents may be uploaded or downloaded. The agent store may provide metadata information about linked agents. The agent store may function as a public orchestrator.

In operation 650, when the agent included in the domain is present in the agent store, the electronic device 101 may succeed in the domain search. When there are a plurality of agents included in the domain, the electronic device 101 may select one based on user preferences stored in memory, considering the metadata of the searched agent.

In operation 660, the electronic device 101 may download the agent searched from the agent store. The electronic device 101 may inform the user of the need for agent download and download the agent according to the user's final approval. The downloaded agent may become available on the electronic device 101, and metadata for the agent may be stored in the orchestrator 320 of the electronic device 101.

In operation 670, the electronic device 101 may output information about the agent searched by the orchestrator 320 (operation 630, Yes) or searched and downloaded from the agent store (operation 650, Yes). The agent information may include metadata about the agent.

In operation 680, when the search for the domain fails in both the orchestrator 320 and the agent store, the electronic device 101 may output a search failure. Since there is no suitable agent to perform the task, the electronic device 101 may suggest a domain change or agent generation for the task.

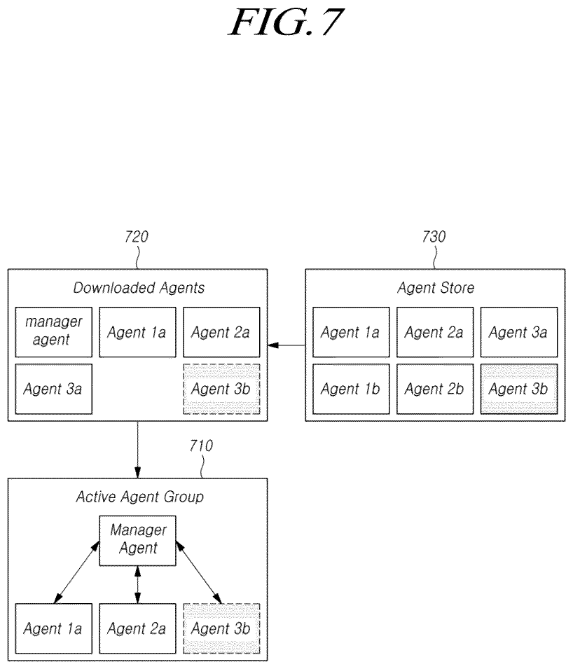

FIG. 7 illustrates an example of agent groups according to an embodiment of the disclosure.

An electronic device (e.g., the electronic device 101 of FIG. 1) may configure multi-agent to process the user query. Among the agents (the downloaded agents 720) stored in the memory (e.g., the memory 130 of FIG. 1) of the electronic device 101, the currently operating multi-agent may be referred to as an active agent group 710. The metadata for the agents 720 included in the memory 130 may be stored and managed in the orchestrator (e.g., the orchestrator 320 of FIG. 3) of the electronic device 101. The electronic device 101 may search for the agent to perform the task among the agents 720 included in the memory 130 using the orchestrator 320. When the electronic device 101 fails in the agent that is search by the orchestrator 320, the electronic device 101 may search for the agent in the agent store 730.

For example, the agents 720 included in the memory 130 may include a manager agent, agent 1a, agent 2a, and agent 3a. The agent store 730 may include agent 1a, agent 1b, agent 2a, agent 2b, agent 3a, and agent 3b. The electronic device 101 may search for the agent included in a first domain among the downloaded agents 720. As a result of searching the first domain, the electronic device 101 may output agent 3a. When the electronic device 101 determines that agent 3a needs to be replaced, the electronic device 101 may search for another agent included in the first domain in the agent store 730 and output agent 3b as a result of the search. The electronic device 101 may download agent 3b from the agent store 730 and may include the agent 3b in the multi-agent 710.

The electronic device 101 may search for and download a necessary agent by referring to metadata for agents included in the memory 130 and agents included in the agent store 730. The electronic device 101 may generate a new agent according to a user input. The electronic device 101 may store the generated new agent 720 in the memory 130 and may also upload the generated new agent 720 to the agent store 730 according to a user request. The electronic device 101 may also delete the agent in the memory 130.

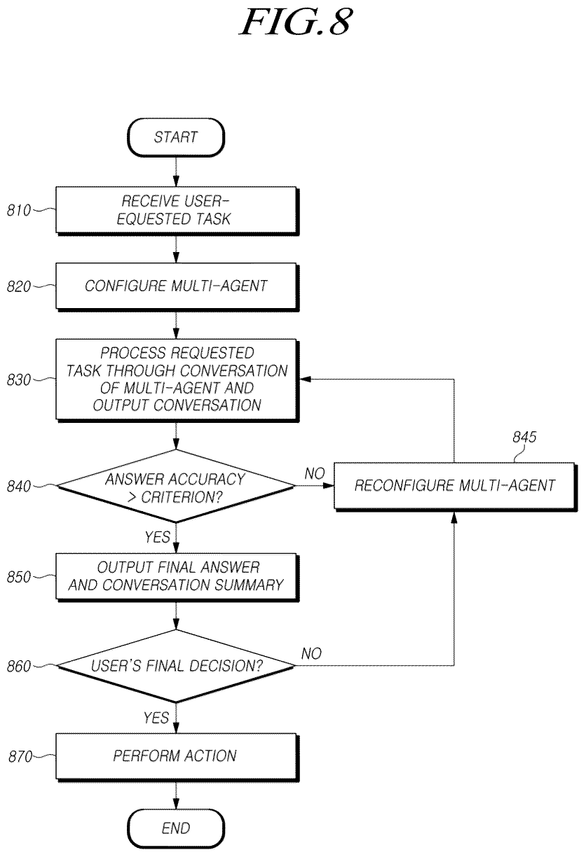

FIG. 8 is a flowchart illustrating operations of processing a user-requested task of an electronic device according to an embodiment of the disclosure.

An electronic device (e.g., the electronic device 101 of FIG. 1) may derive an answer while reconfiguring the multi-agent automatically or manually while processing the user-requested task. In the following embodiment, each operation may be sequentially performed, but, in other embodiments, each operation is not necessarily performed sequentially. For example, the order of the operations may be changed, and at least two operations may be performed in parallel.

In operation 810, the electronic device 101 may receive a user-requested task.

In operation 820, the electronic device 101 may configure multi-agent for processing the user-requested task.

In operation 830, the electronic device 101 may process the requested task through the conversation among the multi-agent and output the conversation among the multi-agent. The electronic device 101 may decompose the user-requested task into one or more sub tasks, select agents to process each sub task, and generate a natural language prompt to delegate the sub tasks to the agents. The multi-agent may transmit the prompt and generate an answer to the prompt according to the processing order of the sub tasks. The electronic device 101 may provide the conversation among the multi-agent to the user through an output device (e.g., the display module 160 of FIG. 1). The user may perceive the processing progress of the user-requested task through the conversation among the multi-agent.

In operation 840, the electronic device 101 may determine whether the accuracy of the answer generated by a first agent during the conversation among the multi-agent is a predetermined criterion or more. Each agent based on an LLM may generate an answer to an input prompt and output a result indicating that an answer may not be generated when the answer accuracy is lower than the predetermined criterion. The electronic device 101 may reconfigure the multi-agent when the answer accuracy during the conversation among the multi-agent is lower than the predetermined criterion.

In operation 845, the electronic device 101 may reconfigure the multi-agent when the answer of the first agent is lower than the predetermined criterion. The electronic device 101 may search for another agent capable of processing the sub task to be performed by the first agent and may include the searched agent in the multi-agent. The added agent may process the prompt for the sub task for which the first agent failed to generate an answer. The electronic device 101 may partially modify the prompt based on the newly added agent.

In operation 850, the electronic device 101 may summarize and output the final answer and conversation derived by the conversation among the multi-agent. A conversation summary may include a summary of the entire conversation among the multi-agents in operation 830. The electronic device 101 may summarize the conversation to include sentences that contain the basis for judgment in reaching the final answer among the entire conversation among the multi-agents.

In operation 860, the electronic device 101 may identify the user's final decision through an input device (e.g., the input module 150 of FIG. 1). The final decision may be referred to as the user intention, including whether to accept the final answer to the user-requested task. The user may request a modification or ask additional questions for the final answer to the user-requested task. When the final decision is not completed, the electronic device 101 may reconfigure the multi-agent. By reconfiguring the agent to process the user's modification request or additional questions, the modification request or additional questions may be processed. This process may be repeated, and ultimately, the user may accept the final answer.

In operation 870, the electronic device 101 may perform one or more actions included in the final answer as the user's final decision is completed. The action may be one or more execution results. For example, when the user-requested task corresponds to “Help me plan a summer vacation,” and the electronic device 101 provides a travel plan as the final answer, and the user makes a final decision, a reservation action to confirm the travel plan may be needed. The reservation action may include booking flights and accommodation.

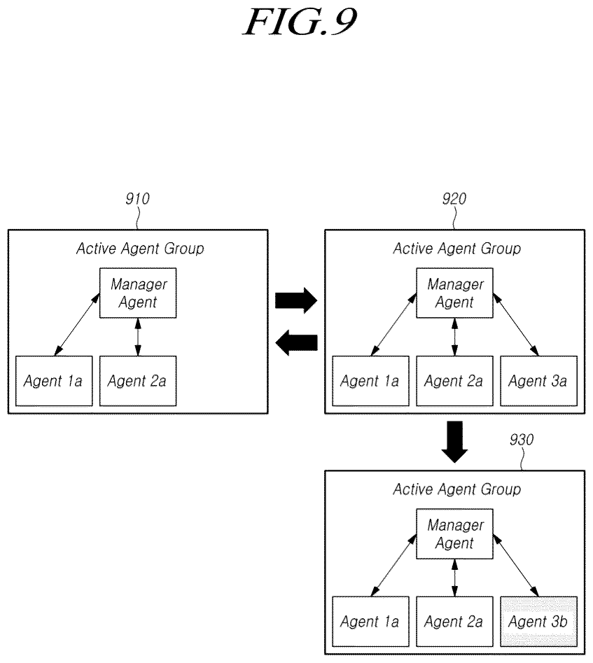

FIG. 9 illustrates an example of an activated agent group according to an embodiment of the disclosure.

An electronic device (e.g., the electronic device 101 of FIG. 1) may configure multi-agent to process the user-requested task. The agents included in the multi-agent may be referred to as an active agent group. The electronic device 101 may reconfigure the multi-agent while processing the user-requested task. For example, by adding agent 3a to the first active agent group 910, the reconfigured multi-agent may become the second active agent group 920. Conversely, by removing agent 3a from the second active agent group 920, the reconfigured multi-agent may become the first active agent group 910. By replacing agent 3a with agent 3b in the second active agent group 920, the reconfigured multi-agent may become the third active agent group 930. The active agent group may allow for the addition, modification, and deletion of agents while processing the user-requested task. However, the active agent group is configured to process the user-requested task and does not permanently add, replace, or delete agent stored in memory managed by the orchestrator.

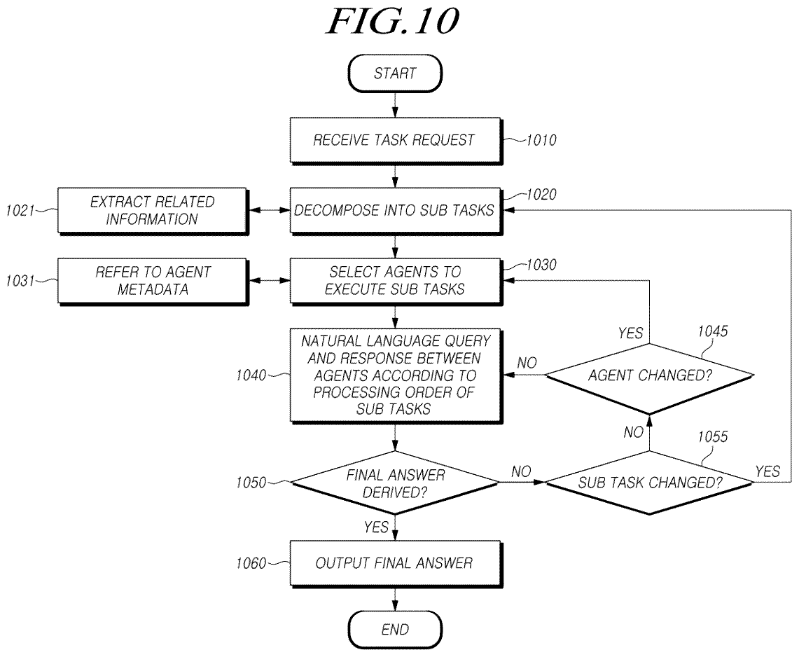

FIG. 10 is a flowchart illustrating operations of processing a user-requested task of an electronic device according to an embodiment of the disclosure.

An electronic device (e.g., the electronic device 101 of FIG. 1) may process the user-requested task through real-time collaborative operations of the multi-agent. In the following embodiment, each operation may be sequentially performed, but, in other embodiments, each operation is not necessarily performed sequentially. For example, the order of the operations may be changed, and at least two operations may be performed in parallel.

In operation 1010, the electronic device 101 may receive the task request.

Operations 1020 and 1021 interact with each other, and the electronic device 101 may analyze the requested task and decompose the analyzed requested task into one or more sub tasks. A processing order for the one or more sub tasks may be determined. To analyze the requested task, the electronic device 101 may extract information related to the requested task from memory (e.g., the short-term memory 221 and long-term memory 222 of FIG. 2). For example, the electronic device 101 may get access to data stored in the short-term memory 221 in relation to the task request currently in process. The electronic device 101 may get access to data stored in the long-term memory 222, such as user preferences.

Operations 1030 and 1031 interact with each other, and the electronic device 101 may select agents to execute the sub tasks by referring to metadata for the agents. The metadata for the agents may include information about the goals and functions each agent may perform and may also include information about the tools or APIs utilized by each agent. As a type of agent managing metadata for the agents, there may be the orchestrator (e.g., orchestrator 320 of FIG. 3). The orchestrator may be aware of metadata for at least one agent stored in the electronic device 101 and may search for agents capable of processing the sub tasks. When there are a plurality of agents for processing a first sub task, the electronic device 101 may select any one agent according to user preferences or recent usage history.

In operation 1040, the electronic device 101 may generate natural language queries and responses among the agents according to the processing order of the sub tasks. The natural language query may be a prompt in the input data format of an LLM.

In operation 1050, the electronic device 101 may determine whether the final answer is derived when each sub task is processed and a response is generated, or when the processing of all sub tasks is completed. While the final answer is not derived, the electronic device 101 may determine whether to change the sub task or agent according to the response generated by the agent corresponding to the sub task at each step.

When each agent, based on the LLM, determines that the accuracy for generating an answer to the prompt is lower than a first threshold criterion, each agent may determine that an answer may not be generated. In this case, the electronic device 101 may determine to change the sub task (operation 1055, Yes). The electronic device 101 may change the sub task and regenerate a prompt to delegate the changed sub task to the agent (operations 1030 to 1040).

Each agent based on the LLM generates an answer to the prompt, but the electronic device 101 may determine that the answer is insufficient to proceed to the next sub task. In this case, the electronic device 101 may determine not to change the sub task (operation 1055, No), but determine to change the agent (operation 1045, Yes). The electronic device 101 may reselect the agent to process the sub task (operation 1030).

When each agent based on the LLM determines that the answer generated according to the delegated prompt does not require a change in the sub task or agent, the electronic device 101 may proceed to the next sub task (operation 1050, operation 1055, and operation 1045, No).

The electronic device 101 may derive the final answer to the requested task by repeating operations 1020 to 1050.

In operation 1060, the electronic device 101 may output the final answer when all sub tasks are completed, or the final answer is derived according to the conversation among the plurality of agents.

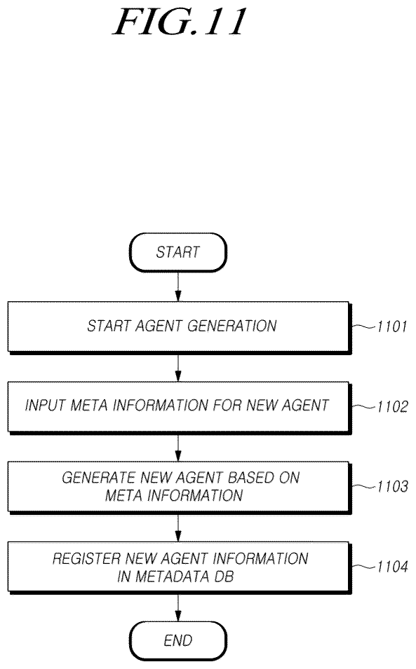

FIG. 11 is a flowchart illustrating operations of generating an agent of an electronic device according to an embodiment of the disclosure.

An electronic device (e.g., the electronic device 101 of FIG. 1) may generate a new agent based on a user input. In the following embodiment, each operation may be sequentially performed, but is not necessarily performed sequentially. For example, the order of each operation may be changed, and at least two operations may be performed in parallel.

In operation 1101, the electronic device 101 may initiate agent generation. For example, the electronic device 101 may receive a user input (e.g., a touch to the agent generation icon) to start the agent generation function.

In operation 1102, the electronic device 101 may receive meta information for the new agent. The meta information includes one or more pieces of information about the agent and may include metadata for defining the agent. The metadata may include goals to be achieved through the agent, provided functions, tools or APIs used, training data, implementation specifications (e.g., a LLM type) or such LLM information, and instructions describing generation conditions. In addition to metadata, the meta information may further include a profile image, a trigger condition, and the agent name for the new agent.

In operation 1103, the electronic device 101 may generate the new agent based on the meta information. For example, tools or APIs used by the electronic device 101 may be matched from among the tools or APIs provided by the electronic device 101. The electronic device 101 may be programmed to use an LLM that meets the specifications required by the new agent from among the supported LLMs. The electronic device 101 may obtain the training data of the meta information to train the LLM of the new agent with the training data.

In operation 1104, the electronic device 101 may register new agent information in a metadata DB. The metadata DB may be managed by the agent managing the metadata (e.g., the orchestrator 320 of FIG. 3). The electronic device 101 may perform an agent search based on the metadata for the newly generated agent.

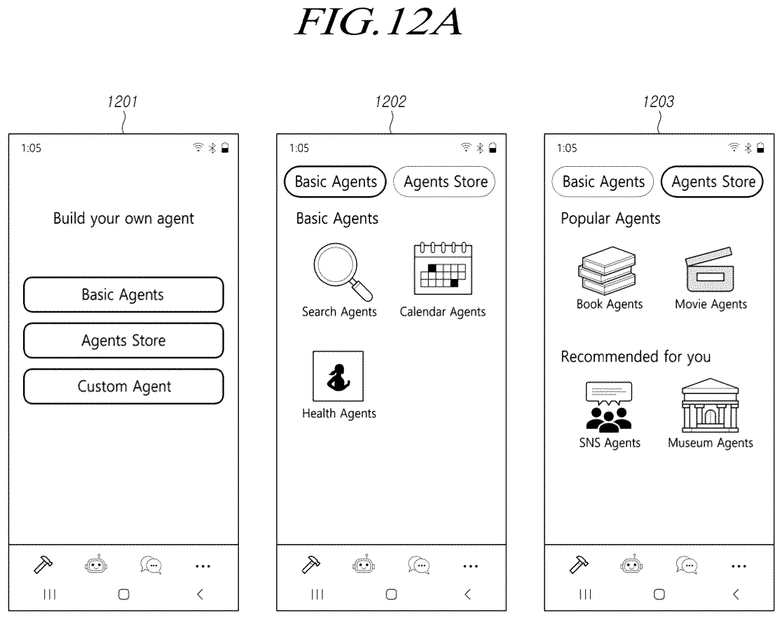

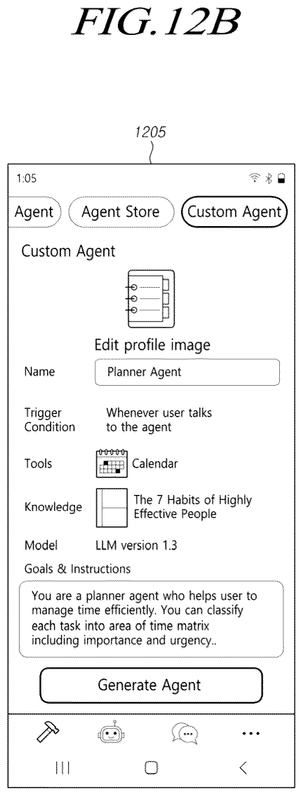

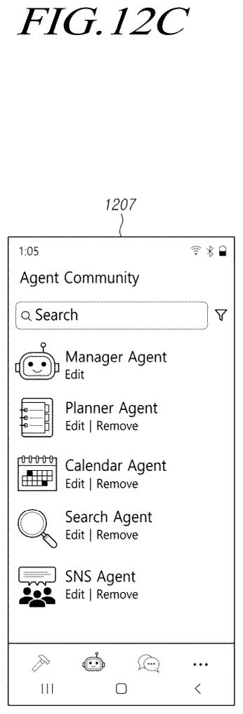

FIG. 12A illustrates an example of an agent selection screen of an electronic device according to an embodiment of the disclosure.

FIG. 12B illustrates an example of a new agent generation screen of an electronic device according to an embodiment of the disclosure.

FIG. 12C illustrates an example of a user agent list screen of an electronic device according to an embodiment of the disclosure.

According to an embodiment, the electronic device 101 includes at least one agent in the memory (e.g., the memory 130 of FIG. 1) and may search and download agents from the agent store as needed, and generate new agents according to user requests.

In an embodiment, the electronic device 101 may provide a user interface screen that allows the user to identify information about agents, select agents, and manually configure multi-agent.

A first screen 1201 may include icons for selecting basic agents provided by the electronic device 101, an agent store, and custom agents.

A second screen 1202, as a basic agent screen, may display some of the agents included in the electronic device 101. For example, the second screen 1202 may include a search agent, a calendar agent, and a health agent.

A third screen 1203, as the agent store screen, may display downloadable agents. For example, the third screen 1203 may display items of popular agents and recommended agents.

A fifth screen 1205, as a custom agent screen, is a user input screen for generating new agents. The fifth screen 1205 may include items for inputting one or more pieces of information for new agent generation. For example, the fifth screen 1205 may include the new agent name, start conditions (also referred to as trigger conditions), tools, training data (knowledge), a LLM type (also referred to as an LLM model), goals to be achieved, and instructions (also referred to as ‘goals & instructions’). The electronic device 101 may generate the new agent based on the input data obtained through the fifth screen 1205. For example, the electronic device 101 may generate an agent program that meets the metadata of the new agent.

A seventh screen 1207 is a screen displaying agents included in the electronic device 101. The multi-agent may be disposed at the top according to usage frequency, importance, or user preference. For example, the seventh screen 1207 may display a manager agent at the topmost end and may sequentially list a planner agent, a calendar agent, a search agent, and an SNS agent.

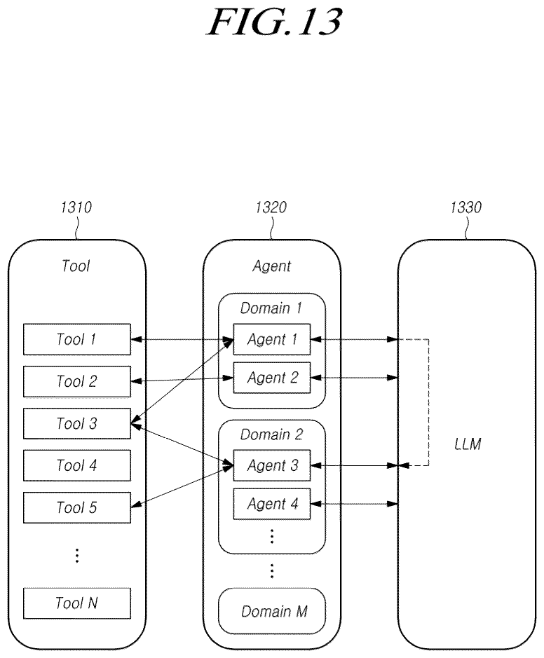

FIG. 13 illustrates an example of a tool invocation operation of LLM-based agents according to an embodiment of the disclosure.

According to an embodiment, the electronic device 101 may allow at least one agent 1320 to use at least one tool 1310 and may allow the use of at least one LLM 1330. The electronic device 101 may include a plurality of agents 1320 having various objectives and functions. Each agent 1320 may be capable of natural language conversation based on the at least one LLM 1330 and may provide one or more functions to achieve a set objective. Each agent 1320 may use basic tools 1310 included in the electronic device 101 to execute functions. The basic tools 1310 represent modularized tools and may include, e.g., a calendar, phone, contacts, web search, user interface guide, notifications, messages, calculator, translator, or document generator. According to an update to or the generation of a modularized tool in the electronic device 101, the basic tools 1310 may be added or modified. The electronic device 101 may include at least one LLM 1330 but may be physically equipped with only one LLM 1330. Alternatively, the LLM 1330 may include a plurality of LLMs fine-tuned for specific functions in the form of on-device LLMs.

Each agent 1320 may perform conversations using natural language prompts and responses using the LLM 1330. For example, a first agent may query a third agent by transmitting a prompt to the LLM 1330, and the response from the third agent may be output in natural language form and delivered to the first agent. The first agent may use a first tool and a third tool to execute functions. The third agent may use a third tool and a fifth tool to execute functions. The first agent may belong to a first domain, and the third agent may belong to a second domain. Agents may belong to any one of the plurality of domains. An agent providing a plurality of functions may belong to a plurality of domains.

Each tool 1310 may execute a function and reply with a result in response to an invocation by the agent. The LLM 1330 may generate and reply with an answer in response to the prompt transmission by the agent. The electronic device 101 may perform collaboration through the conversation among the multi-agent through interactions among each tool 1310, each agent 1320, and the LLM 1330.

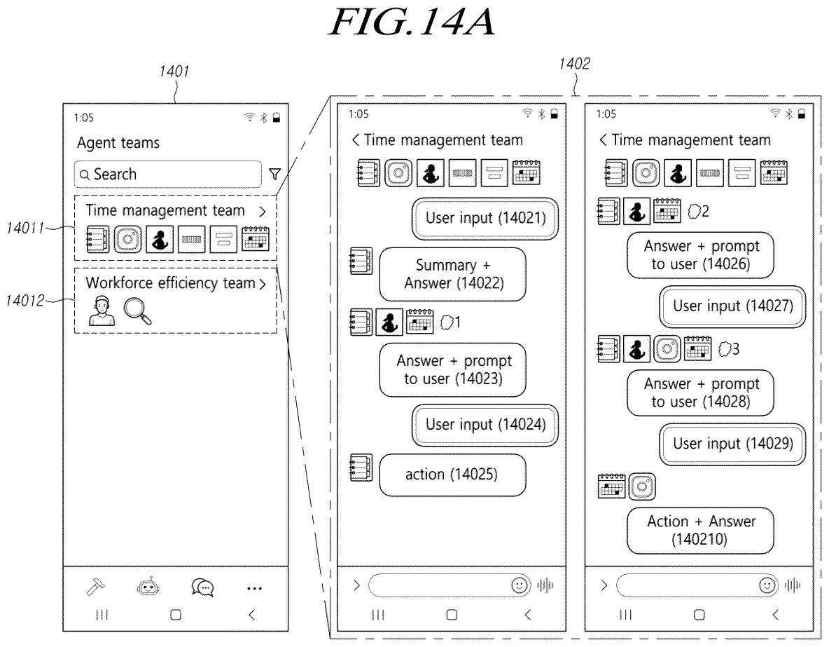

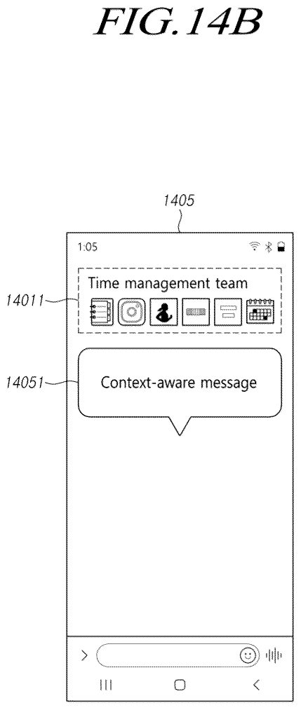

FIG. 14A illustrates an example of a conversation screen of a user-configured agent team according to an embodiment of the disclosure.

FIG. 14B illustrates an example of an action screen of a user-configured agent team according to an embodiment of the disclosure.

An electronic device (e.g., the electronic device 101 of FIG. 1) may manually generate an agent team based on a user input. Unlike the above-described embodiment (e.g., FIG. 3) in which a manager agent (e.g., the manager agent 310 of FIG. 3) configures multi-agent to process a user-requested task, the agent team configured by user input may allow agents in the team to process the tasks delegated by the user.

A first screen 1401 may include agent teams configured by the user. The agent team may include icons representing the included agents and a team name. A first agent team 14011 may be a time management team and may include scheduling, SNS, health, book, video, and calendar agents. A second agent team 14012 may be a work efficiency team and may include productivity and search agents.

A second screen 1402 exemplifies a conversation in which the user delegates a task to the first agent team 14011. The electronic device 101 may receive a user input 14021 for the task request. For example, the user may request the task “These are my usual activities: morning exercise, reading, watching TV with my wife, studying math with my child, playing games with my child, using SNS; classify them according to the time management matrix.” The scheduling agent of the first agent team 14011 may classify the user-requested tasks according to importance and urgency. As a classification result, 1. Morning exercise and studying math with the child may be classified as important and urgent. 2. Reading and playing games with the child may be classified as important but not urgent. 3. Watching TV with the wife and using SNS may be classified as neither important nor urgent. The scheduling agent may output a summarized answer 14022 of the classification content on the second screen 1402. The scheduling agent may collaborate with the health agent and the calendar agent to derive a schedule of 1. Morning exercise every morning at 6 a.m. and studying math with the child every Monday evening at 8 p.m. The scheduling agent may output a natural language response 14023 on the second screen 1402, stating, “Shall I register the schedule by prioritizing the morning exercise and math study with the child as important and urgent, with morning exercise at 6 AM daily and math study with the child at 8 PM every Monday?” On the second screen 1402, the reception of a final decision 14024 from the user, “Yes, schedule the math study on Wednesday,” may be displayed. The calendar agent may register the schedule reflecting the user's final decision 14024 as “morning exercise at 6 a.m. daily, math study with the child at 8 p.m. every Wednesday” and may display the action content 14025 on the second screen 1402.

Sequentially, the scheduling agent may collaborate with the calendar agent and the book agent to derive a schedule for registering available weekend time for 2. reading books and playing games with my child. The scheduling agent may output a natural language answer 14026 on the second screen 1402, stating, “Reading books and playing games with your child are important but not urgent. I will register the schedule during available weekend time to maintain consistency. Shall I inform you when a new book in your usual interest area of novels is released?” On the second screen 1402, the reception of a final decision 14027 from the user, “Yes, that's good,” may be displayed. The scheduling agent may collaborate with the movie agent, calendar agent, and SNS agent to derive a schedule for limit watching TV to one hour per week and reducing SNS usage for 3. watching TV with my wife and using SNS. The scheduling agent may output a natural language answer 14028 on the second screen 1402, stating, “Watching TV with your wife is not important or urgent. Shall I limit it to one hour per week? It also seems advisable to reduce SNS usage.” On the second screen 1402, the reception of a final decision 14029 from the user, “Watching TV for two hours a week would be good. I will not use SNS, but I am interested in travel news from acquaintances, so please inform me only of such news,” may be displayed. The calendar agent and SNS agent may reflect the user's final decision 14029 to output the action content 140210, “I will register the TV schedule and keep you informed of travel news on SNS on the second screen 1402.

According to an embodiment, the electronic device 101 may perceive the circumstance through the agent and generate a message according to, or based on, the circumstance and provide the generated message to the user. For example, the first agent team 14011 may register a schedule and output notifications related to the schedule over time, as an action for the user-requested task.

On the third screen 1405, the first agent team 114011 may output a message suitable for the circumstance as a first alarm 14051. For example, messages such as “It is time to exercise at 6 a.m. Try to run for 30 minutes as you did yesterday” or “You have not used SNS for a week and are keeping your goal well. OO is travelling to Jeju Island,” may be output.

An embodiment of the disclosure and terms used therein are not intended to limit the technical features described in the disclosure to specific embodiments, and should include various modifications, equivalents, or substitutes of the embodiment. With regard to the description of the drawings, similar reference numerals may be used to refer to similar or related elements. A singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). If an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., through a wire or wires), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to one or more embodiments, the integrated component may still perform one or more functions of each of the plurality of components in the same or similar manner as they are performed by a corresponding one of the plurality of components before the integration. According to one or more embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
an input device;
a display;
memory storing instructions and a plurality of programs corresponding to a plurality of agents; and
at least one processor including processing circuitry,
wherein the instructions, when executed by the at least one processor individually or collectively, cause the electronic device to:
receive a user query through the input device;
identify, by a first agent among the plurality of agents, a requested task from the user query;
decompose the requested task into at least one sub task;
request, from a second agent managing metadata for the plurality of agents, metadata for at least one agent capable of processing the at least one sub task;
receive, from the second agent, an answer including the metadata;
configure, based on the answer, a multi-agent by selecting at least one agent to process the at least one sub task from among the plurality of agents;
perform a natural language conversation to delegate the at least one sub task to each agent of the multi-agent; and
determine whether to reconfigure the multi-agent based on a result of the natural language conversation.

2. The electronic device of claim 1, wherein the instructions, when executed by the at least one processor individually or collectively, cause the electronic device to:
based on determining that a third agent is incapable of generating an answer to a first sub task during a conversation among the multi-agent, request, by the first agent from the second agent, metadata for another agent to process the first sub task;
receive, from the second agent, an answer including metadata for a fourth agent capable of processing the first sub task; and
reconfigure, by the first agent, the multi-agent to include the fourth agent.

3. The electronic device of claim 2, wherein the instructions, when executed by the at least one processor individually or collectively, cause the electronic device to:
process a rest of the at least one sub task through a conversation among the reconfigured multi-agent;
based on completion of the conversation among the reconfigured multi-agent, generate a final answer and summary information for the conversation among the reconfigured multi-agent; and
output the final answer and the summary information through the display.

4. The electronic device of claim 1, wherein the instructions, when executed by the at least one processor individually or collectively, cause the electronic device to reflect, by the first agent, each response according to the conversation among the multi-agent to remaining sub tasks.

5. The electronic device of claim 4, wherein the instructions, when executed by the at least one processor individually or collectively, cause the electronic device to:
based on at least one sub task of the remaining sub tasks being changed by reflecting each response to the conversation among the multi-agent, determine, by the first agent, whether the multi-agent are capable of processing the changed at least one sub task;
based on determining that the multi-agent is incapable of processing the changed at least one sub task, request, from the second agent, metadata for an additional agent to process the changed at least one sub task;
receive, from the second agent, the metadata for the additional agent; and
reconfigure, by the first agent, the multi-agent to include the additional agent.

6. The electronic device of claim 1, wherein the instructions, when executed by the at least one processor individually or collectively, cause the electronic device to:
display, by the first agent, information about the multi-agent through the display; and
sequentially output a natural language prompt query and response, in an inter-agent conversation format through the display based on a real-time conversation of the multi-agent.

7. The electronic device of claim 1, wherein the instructions, when executed by the at least one processor individually or collectively, cause the electronic device to:
receive a user input through the input device during the conversation among the multi-agent; and
reflect, by the first agent, the user input to a remaining sub task among the at least one sub task.

8. The electronic device of claim 2, wherein the instructions, when executed by the at least one processor individually or collectively, cause the electronic device to:
add the fourth agent to the multi-agent or replace the third agent with the fourth agent; and
output a guide for reconfiguring the multi-agent through the display.

9. The electronic device of claim 1, wherein the instructions, when executed by the at least one processor individually or collectively, cause the electronic device to:
receive information for agent generation through the input device;
generate a new agent based on the information; and
store the new agent and the information for the new agent in the memory.

10. The electronic device of claim 9, wherein the information includes at least one of an agent name, a trigger condition, a target, a function, a tool, an API, training data, LLM information, or a generation condition.

11. The electronic device of claim 1, wherein the instructions, when executed by the at least one processor individually or collectively, cause the electronic device to generate, by the plurality of agents, an answer to an input prompt based on a large language model.

12. The electronic device of claim 1, wherein the instructions, when executed by the at least one processor individually or collectively, cause the electronic device to generate the answer or perform an action related to the answer, by the plurality of agents, using a tool corresponding to one or more functions stored in the memory.

13. A method of an electronic device, the method comprising:
receiving a user query through an input device of the electronic device;
identifying a requested task from the user query by a first agent among a plurality of agents stored in memory of the electronic device;
decomposing the requested task into at least one sub task;
requesting, from a second agent managing metadata for the plurality of agents, metadata for at least one agent capable of processing the at least one sub task;
receiving, from the second agent, an answer including the metadata;
configuring a multi-agent by selecting at least one agent to process the at least one sub task, from among the plurality of agents based on the answer;
performing a natural language conversation to delegate the at least one sub task to each agent of the multi-agent; and
determining whether to reconfigure the multi-agent based on a result of the natural language conversation.

14. The method of claim 13, wherein the determining whether to reconfigure the multi-agent comprises:
based on determining that a third agent is incapable of generating an answer to a first sub task during a conversation among the multi-agent, requesting, by the first agent from the second agent, metadata for another agent to process the first sub task;
receiving, from the second agent, an answer including metadata for a fourth agent capable of processing the first sub task; and
reconfiguring, by the first agent, the multi-agent to include the fourth agent.

15. The method of claim 14, further comprising:
processing a rest of the at least one sub task through a conversation among the reconfigured multi-agent;
based on a completion of the conversation among the reconfigured multi-agent, generating a final answer and summary information for the conversation among the multi-agent; and
outputting the final answer and the summary information through a display.

16. The method of claim 13, wherein the performing the natural language conversation to delegate the at least one sub task to each agent comprises:
reflecting, by the first agent, each response based on the conversation among the multi-agent to remaining sub tasks;
based on at least one sub task of the remaining sub tasks being changed by reflecting each response to the conversation among the multi-agent, determining, by the first agent, whether the multi-agent is capable of processing the changed at least one sub task;
based on determining that the multi-agent is incapable of processing the changed at least one sub task, requesting, from the second agent, metadata for an additional agent to process the changed sub tasks;
receiving, from the second agent, the metadata for the additional agent; and
reconfiguring, by the first agent, the multi-agent to include the additional agent.

17. The method of claim 13, further comprising:
displaying, by the first agent, information about the multi-agent through the display; and
sequentially outputting a natural language prompt query and response, in an inter-agent conversation format through the display based on a real-time conversation among the multi-agent.

18. The method of claim 13, further comprising:
receiving information for agent generation through the input device;
generating a new agent based on the information; and
storing the new agent and the information for the new agent in the memory,
wherein the information includes at least one of an agent name, a trigger condition, a target, a function, a tool, an API, training data, LLM information, or a generation condition.

19. The method of claim 13, wherein the plurality of agents are configured to generate an answer to an input prompt based on a large language model, and
wherein the plurality of agents are configured to generate the answer or perform an action related to the answer using a tool corresponding to one or more functions stored in the memory.

20. A non-transitory computer-readable storage medium storing instructions, wherein the instructions, when executed by one or more processors individually or collectively, cause the one or more processors to:
receive a user query through an input device;
identify a requested task from the user query by a first agent among a plurality of agents;
decompose the requested task into at least one sub task;
request, from a second agent managing metadata for the plurality of agents, metadata for at least one agent capable of processing the at least one sub task;
receive, from the second agent, an answer including the metadata;
configure, based on the answer, a multi-agent by selecting at least one agent to process the at least one sub task from among the plurality of agents;
perform a natural language conversation to delegate the at least one sub task to each agent of the multi-agent; and
determine whether to reconfigure the multi-agent based on a result of the natural language conversation.
